(19) United States
(12) Patent Application Publication
(10) Pub. No.: US 2006/0075341 A1
(43) Pub. Date: Apr. 6, 2006

(54) MULTI-LANGUAGE SYSTEM AND METHOD FOR QUICKLY SELECTING FONT FILE CORRESPONDING TO CHARACTER FROM FONT DATABASE

(76) Inventors: Tsung-I Lin, Taipei Hsien (TW); Yu-Chuan Yang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/904,757

(22) Filed: Nov. 25, 2004

(30) Foreign Application Priority Data
Oct. 1, 2004 (TW) 093129885

(51) Int. Cl. G06F 17/21; G06F 17/20; G06F 17/30

(52) U.S. Cl. 715/542; 707/3; 704/8

(57) ABSTRACT

A multi-language system for quickly selecting a font file corresponding to a character includes a font database and a code allocation table. The font database contains at least one character code range and at least one font-storage unit. Each font-storage unit is for storing at least one font file corresponding to a natural language, and each font file corresponds to a character code. A method for quickly selecting the font file includes finding a character code range containing the character code from the code allocation table according to the character code to obtain a font-storage unit corresponding to the character code; obtaining a font file address of a font file corresponding to the character code from the font-storage unit according to the character code; and selecting the font file corresponding to the character code from the font-storage unit according to the address of the font file address.

### BACKGROUND

The present invention relates to multi-language systems, and more specifically, to a multi-language system and a method for selecting a font file corresponding to a character from a font database.

With the arrival of the globalization era, products are becoming more and more internationalized. A Man-Machine Interface (MMI) only supporting a single natural language does not meet users' needs. While purchasing products, like a mobile phone, users concern not only the available functions, but also the MMI design of the mobile phone. Generally speaking, users all expect a multi-language interface to be installed on the mobile phone. Hence, most mobile phones in the present business market contain multi-language systems to support displaying various natural languages.

Please refer to FIG. 1. FIG. 1 is a functional block diagram of a multi-language system 10 according to the related art. The multi-language system 10 is utilized for selecting a font file corresponding to a character from a font database 28. The character corresponds to a character code U. The multi-language system 10 comprises a micro-processor 16, a search module 12, and a font database 28. The search module 12 stored in a storage unit 14 is utilized for selecting a font file corresponding to the character code U from the font database 28 according to the character code U. The font database 28 stored in the storage unit 14 contains a plurality of font-storage units 21. Each font-storage unit 21 corresponds to a natural language, such as Traditional Chinese, Simplified Chinese, and English, etc. A font-storage unit 21 comprises at least one font file, such as a bitmap image file corresponding to a character. Each font file corresponds to a character code U and is stored at a font file address CA in a font-storage unit 21. In addition, as shown in FIG. 1, the micro-processor 16 electrically connected to the storage unit 14 is utilized for controlling the multi-language system 10.

After the multi-language system 10 starts operating, the micro-processor 16 is loaded with the search module 12 and then starts executing the search module 12. After receiving a character code U corresponding to a character, the search module 12 selects a font file corresponding to the character from the font database 28 according to the character code U. A plurality of font files are stored in the font database 28. Each font file corresponds to a character code, and each character corresponds to a character code.

The search module 12 sequentially searches character codes corresponding to all font files stored in the font database 28 for a character code which is identical to the character code U. Next, the search module 12 selects the font file corresponding to the character code U from the font database 28.

As mentioned above, the conventional method for selecting a font file corresponding to a character code is proceeded by way of a sequential search. As an example, it is assumed that the multi-language system 10 supports three natural languages: Traditional Chinese, Japanese, and English. The font-storage units 21 respectively contain Traditional Chinese font files, Japanese font files, and English font files. That is, the font database 28 contains a plurality of Traditional Chinese font files, a plurality of Japanese font files, and a plurality of English font files. As mentioned above, each font file corresponds to a character code. Therefore, the multi-language system 10 contains a plurality of Traditional Chinese character codes, a plurality of Japanese character codes, and a plurality of English character codes.

When the search module 12 is selecting a font file corresponding to an English character, the search module 12 needs to search all Traditional Chinese character codes and all Japanese character codes first and then search all English character codes for the desired character code. Finally, a character identical to the desired character is found in the English character code range. Next, the search module 12 selects the English font file corresponding to the English character code from the font database 28. The above-mentioned method is obviously time-consuming. However, it is desired to effectively utilize the system resources in an embedded system. By heavily occupying the limited system resources, serious problem therefore occurs in the method of the related art.

### SUMMARY

It is therefore an objective of the claimed invention to provide a multi-language system and a method for finding a character code range corresponding to a character first, and then selecting a font file corresponding to the character from a font database.

According to the claimed invention, a method for selecting a font file corresponding to a character from a font database is disclosed. The character corresponds to a character code, and the method is applied in a multi-language system. The multi-language system comprises the font database and a code allocation table. The font database comprises at least one character code range and at least one font-storage unit, wherein each of the font-storage units corresponds to at least one character code range, each of the font-storage unit is for storing at least one font file corresponding to a natural language, and each of the font files corresponds to a character code and is stored at a font file address in the font-storage unit. The code allocation table comprises at least one field, wherein each of the fields is utilized for recording a corresponding relationship between each of the character code ranges and the corresponding font-storage unit. The method comprises (a) finding a character code range containing the character code from the code allocation table according to the character code to obtain a font-storage unit corresponding to the character code range; (b) obtaining a font file address of a font file corresponding to the character code from the font-storage unit according to the character code; and (c) selecting the font file corresponding to the character code from the font-storage unit according to the font file address.

Moreover, according to the claimed invention, a multi-language system for selecting a font file corresponding to a character from a font database is disclosed. The character corresponds to a character code, and the multi-language system comprises: the font database, a code allocation table, and a search module. The font database comprises at least one character code range and at least one font-storage unit, wherein each of the font-storage units corresponds to at least one character code range, each of the font-storage units is utilized for storing at least one font file corresponding to a natural language, and each of the font files corresponds to a character code and is stored at a font file address in the font-storage unit. The code allocation table comprises at least one field, wherein each of the fields is utilized for recording a corresponding relationship between each of the character code ranges and the corresponding font-storage unit. The search module is for finding a character code range containing the character code from the code allocation table according to the character code to obtain a font-storage unit corresponding to the character code range; obtaining a font file address of a font file corresponding to the character code from the font-storage unit according to the character code; and selecting the font file corresponding to the character code from the font-storage unit according to the font file address.

The present invention provides a multi-language system and a method for quickly selecting a font file corresponding to a character from a font database. The method firstly finds a character code range containing a character code of the character from the code allocation table. That is, the character code is compared with a maximum value and a minimum value of each character code range. If the character code is greater than a minimum value and less than a maximum value of a specific character code range, the character code is in the character code range. Next, the multi-language system and the method according to the present invention select the font file corresponding to the character code. Consequently, the multi-language system and the method according to the present invention can efficiently save system resources applied in the embedded system. Moreover, no matter whether the font files of characters corresponding to the natural language are equal to a fixed width value or not, the multi-language system and the method can quickly select the font files.

These and other objectives of the present invention will no doubt become obvious to those of ordinary skill in the art after reading the following detailed description of the preferred embodiment that is illustrated in the various figures and drawings.

### BRIEF DESCRIPTION OF DRAWING

FIG. 1 is a functional block diagram of a multi-language system according to the related art.

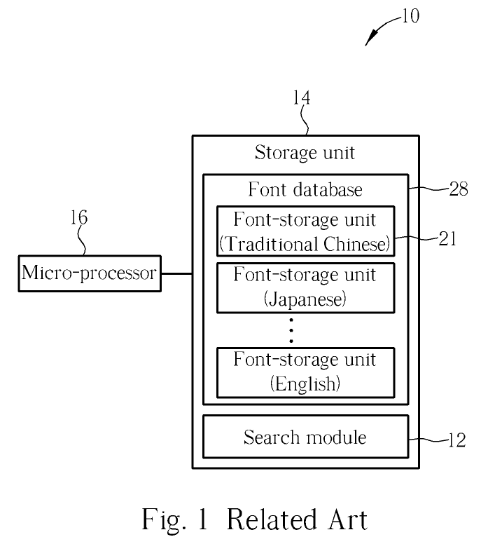

FIG. 2 is a functional block diagram of a multi-language system according to the present invention.

FIG. 3 is a flowchart describing the multi-language system in FIG. 2 for selecting a font file corresponding to a character from the font database.

FIG. 4 is a functional block diagram of another multi-language system according to the present invention.

FIG. 5 is a flowchart describing the multi-language system in FIG. 4 for selecting a font file corresponding to a character from a font database.

### DETAILED DESCRIPTION

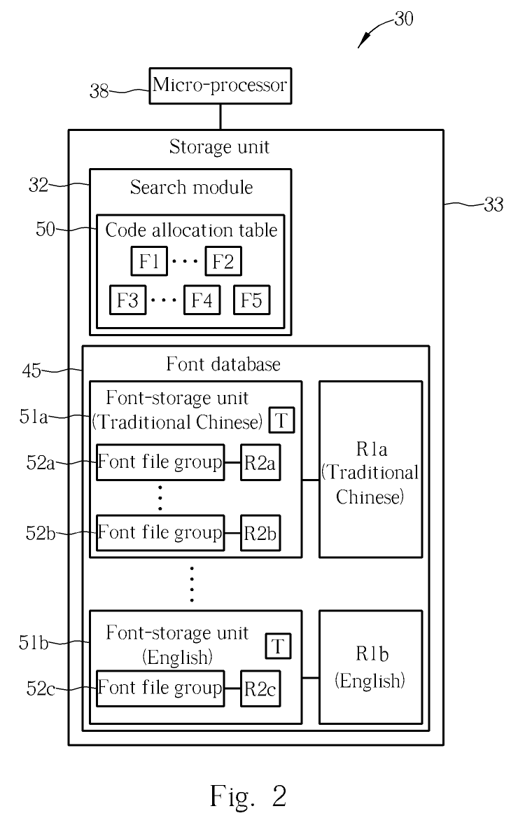

Please refer to FIG. 2. FIG. 2 is a functional block diagram of a multi-language system 30 according to the present invention. The multi-language system 30 comprises a storage unit 33 and a micro-processor 38. In the present embodiment, the micro-processor 38 is electronically connected to the storage unit 33 for controlling the multi-language system 30. The storage unit 33 stores a program code of a search module 32. Therefore, the program code of the search module 32 is loaded into the micro-processor 38 and then is executed. The storage unit 33 further stores a font database 45. The multi-language system 30 is utilized for selecting a font file corresponding to a character from a font database 45. The character corresponds to a character code U. The font database 45 contains character code ranges R1a, R1b and corresponding font-storage units 51a, 51b. The font-storage unit 51a corresponds to the character code range R1a, and the font-storage unit 51b corresponds to the character code range R1b. As shown in FIG. 2, the font-storage unit 51a stores Traditional Chinese font files, and the font-storage unit 51b stores English font files. The font-storage unit 51a stores a plurality of font file groups 52a, 52b and corresponding character code sub-ranges R2a, R2b. The font-storage unit 51b stores a font file group 52c and a corresponding character code sub-range R2c. Each of the font file groups 52a, 52b, 52c has at least one font file (a bitmap image file) corresponding to a natural language. Each font file corresponds to a character code U and is stored at a font file address CA. Please note that in the code allocation table 50, a character code range corresponding to a natural language (i.e. the character code range R1a) contains all character code sub-ranges corresponding to the natural language (i.e. the character code sub-range R2a and R2b).

In the present embodiment, the code allocation table 50 stored in the search module 32 comprises a plurality of fields. Each field is utilized for recording a corresponding relationship between each character code range and the font-storage unit. As shown in FIG. 2, a field F1 records a relationship between the character code range R1a and the corresponding font-storage unit 51a. A field F2 records a relationship between the character code range R2a and the corresponding font-storage unit 52a. Moreover, the code allocation table 50 further comprises fields F3, F4 and F5. The field F3 records a relationship between the character code range R2a and the corresponding font file group 52a. The field F4 records a relationship between the character code range R2b and the corresponding font file group 52b. The field F5 records a relationship between the character code range R2c and the corresponding font file group 52c.

In the present embodiment, the character code U is a unicode, and the code allocation table 50 is a unicode allocation table. Additionally, in this embodiment, the multi-language system 30 and the related method for selecting a font file corresponding to a character from a font database are preferably applied in a mobile unit, such as a mobile phone conforming to a GSM (global system for mobile communications) specification. Please note that the multi-language system 30 and the related method according to the present invention are not limited to the above-mentioned applications; that is, they can be applied in any apparatuses for providing a function of quickly selecting a desired font file. Additionally, in the present embodiment, two natural languages, Traditional Chinese and English, are taken as examples for describing operations of the multi-language system 30. Therefore in the present embodiment, the font database 45 comprises two character code ranges R1a, R1b and two font-storage units 51a, 51b. The character code range R1a and the font-storage unit 51a correspond to Traditional Chinese, and the character code range R1b and the font-storage unit 51b correspond to English.

In the present embodiment, the heights of all characters are equal to a height value CH, whereas the widths of the characters can be different according to theirs corresponding natural languages. In the present embodiment, widths of Traditional Chinese characters are equal to a fixed width value, and widths of English characters are not equal to a fixed width value. Each of the font-storage units 51a and 51b records a tag T. The value of the tag T of a specific font-storage unit (i.e. the font-storage unit 51b) is equal a predetermined value, such as a logical value “1”, while widths of the characters corresponding to the font files stored in the font-storage unit are not equal to a fixed width value. Moreover, for each of the characters corresponding to the font files stored in the font-storage unit 51b, the storage unit 33 further records a corresponding width value CV and a corresponding font file address SAC where the font file of the corresponding character is stored. The search module 32 selects a font file corresponding to a specific character from the font-storage unit 51b according to a corresponding width value CV and a corresponding font file address SAC. If widths of characters corresponding to the font files stored in a font-storage unit (i.e. the font-storage unit 51a) are equal to a fixed width value (CW), the tag T is set to be another predetermined value, such as a logical value “0”. Meanwhile, besides the fixed width value CW, a font file address SAS of a first font file of a first character corresponding to a first character code arranged in the beginning of the character code range corresponding to the font file, the storage unit 33 further stores the order OD of the character code corresponding to each of the characters corresponding to the font files stored in the font-storage unit 51a in the character code range. Afterwards, the search module 32 selects a font file corresponding to a specific character according to the fixed width value CW, the font file address SAS of the first font file corresponding to the first character code in the character code range, and the order OD of the character code.

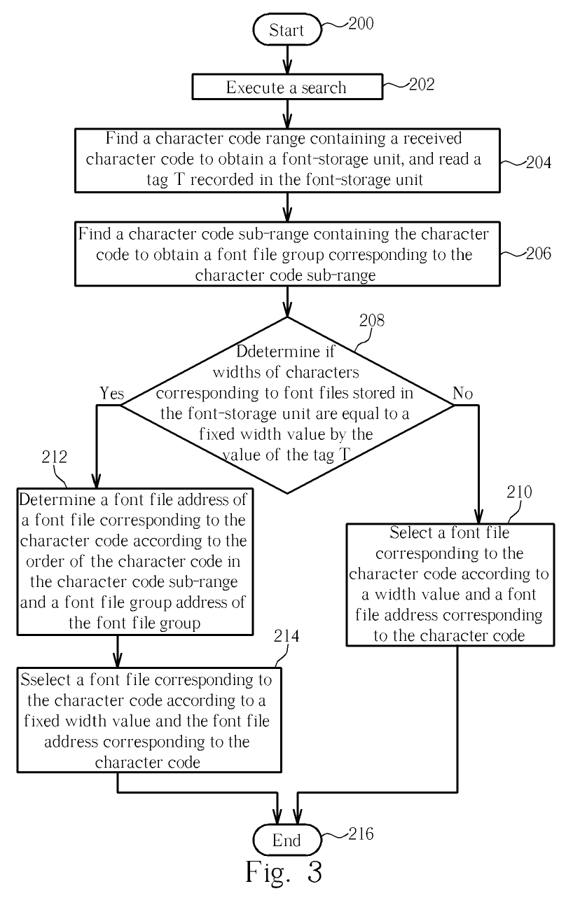

Please refer to FIG. 3. FIG. 3 is a flowchart describing the operation of the multi-language system 30 in FIG. 2 for selecting a font file corresponding to a character from the font database 45. The character corresponds to a character code U. The operations of selecting a font file corresponding to a character comprises the following steps:

Step 200: Start.

Step 202: The micro-processor 38 executes the search module 32.

Step 204: The search module 32 finds a character code range containing the received character code U from the code allocation table 50 according to the character code U to obtain a font-storage unit corresponding to the character code range, and reads a tag T recorded in the font-storage unit.

Step 206: The search module 32 finds a character code sub-range containing the character code U from the font-storage unit according to the character code U to obtain a font file group corresponding to the character code sub-range.

Step 208: The search module 32 determines if widths of the characters corresponding to the font files stored in the font-storage unit are equal to a fixed width value according to the value of the tag T recorded in the font-storage unit. If no (T=1), proceed to step 210; otherwise (T=0), proceed to step 212.

Step 210: The search module 32 selects a font file corresponding to the character code U according to a width value CV and a font file address SAC corresponding to the character code U. Afterwards, go to step 216.

Step 212: The search module 32 determines a font file address SAC of a font file corresponding to the character code U according to the order OD of the character code U in the character code sub-range and a font file group address SAS of the font file group. The font file group address SAS is a font file address SAS of a first font file in the font file group.

Step 214: The search module 32 selects a font file corresponding to the character code U according to the fixed width value CW and the font file address SAC corresponding to the character code U.

Step 216: End.

A detailed description about the multi-language system 30 according to the present invention is described as follows. After a mobile phone is powered on, the multi-language system 30 starts operating (step 200). Then, the search module 32 is loaded into the micro-processor 38 and is executed (step 202). Next, for a clear description about the present invention, two examples using a Traditional Chinese character [symbol] and an English character “h” are given in the present embodiment.

In the present embodiment, a Traditional Chinese character code range contains character codes corresponding to Traditional Chinese characters. The Traditional Chinese character code range can be divided into a plurality of Traditional Chinese character code sub-ranges. Usually, a mobile phone only stores frequently utilized Traditional Chinese font files, and does not store all Traditional Chinese font files. Hence, the character code sub-ranges R2a, R2b in the mobile phone contains the frequently utilized Traditional Chinese characters mentioned above. The search module 32 searches the code allocation table 50 for a character code range containing the character code U corresponding to the Traditional Chinese character [symbol] . The code allocation table 50 records range information about the character code ranges R1a and R1b, where the range information contains a maximum value and a minimum value of each of the character code ranges R1a and R1b. The character code U of the Traditional Chinese character [symbol] is greater than the minimum value of the character code range R1a and less than the maximum value of the character code range R1a, so the search module 32 determines that the character code U is in the character code range R1a corresponding to Traditional Chinese and a font file of the Traditional Chinese character [symbol] is stored in a font-storage unit 51a corresponding to Traditional Chinese. Moreover, the search module 32 reads the tag T stored in the font-storage unit 51a (step 204). Next, the search module 32 searches the font-storage unit 51a for a character code sub-range containing the character code U of the Traditional Chinese character [symbol] . In the present embodiment, the search module 32 determines which one of the character code sub-ranges R2a or R2b contains that character code U by using a binary search method, where each of the character code sub-ranges R2a and R2b contains a maximum value and a minimum value. For example, when the character code U is greater than the minimum value and less than the maximum value of the character code sub-range R2a, that character code U is in the character code sub-range R2a. Therefore, the search module 32 determines that the character code sub-range R2a corresponds to the font file group 52a (step 206).

Afterwards, the search module 32 determines whether widths of the characters corresponding to the font files stored in the font-storage unit 51a are equal to a fixed width value (CW) according to the value of the tag T (T=0) stored in the font-storage unit 51a (step 208). Then, the search module 32 determines a font file address SAC of a font file corresponding to the character code U of the Traditional Chinese character [symbol] according to the order OD of the character code U in the character code sub-range R2a and a font file group address SAS of the font file group 52a. The character code U of the Traditional Chinese character [symbol] is the n^{th} character code in the character code sub-range R2a. The font file address SAC is computed as follows: SAC=SAS+CH×CW×(N−1) (step 212). Therefore, the search module 32 selects a font file corresponding to the character code U according to the fixed width value CW and the font file address SAC of the font file corresponding to the character code U of the Traditional Chinese character [symbol] . That is, the search module 32 reads an amount of data being equal to CH×CW from the font file address SAC (step 2144).

In the following, an English character “h” is taken as an example for describing the above-mentioned flow. There are only 52 English characters: A˜Z and a˜z. Hence, in general, all English characters are in the same character code range, which means the character code range needs not to be divided into a plurality of character code sub-ranges. The search module 32 searches the code allocation table 50 for a character code range containing the character code U corresponding to English character “h”. The code allocation table 50 records range information about the character code ranges R1a and R1b, wherein the range information contains a maximum value and a minimum value of each of the character code ranges R1a and R1b. Since the character code U of the English character “h” is greater than the minimum value of the character code range R1b and less than the maximum value of the character code range R1b, the search module 32 knows that the character code U is in the character code range R1b corresponding to English and a font file of the English character “h” is stored in a font-storage unit 51b corresponding to English. Moreover, the search module 32 reads the tag T stored in the font-storage unit 51b (step 204). Next, because the character code range R1b has only one character code sub-range R2c (for English characters, the character code range R1b is equal to the character code sub-range R2c), the font-storage unit 51b corresponding to English has only one font file group 52c (the font-storage unit 51b is equal to the font file group 52c). Hence, the search module 32 knows that the character code U must be in the character code sub-range R2c (step 206). The search module 32 then determines that widths of font files stored in the font-storage unit 51b are not equal to a fixed width value according to the value of the tag T (T=1) stored in the font-storage unit 51b (step 208). Then, the search module 32 selects a font file corresponding to the character code U according to a width value CV and a font file address SAC of the font file corresponding to the character code U of the English character “h”. That is, the search module 32 reads an amount of data being equal to CH×CV from the font file address SAC (step 210).

However, in the above-mentioned embodiment, the multi-language system 30 does not support displaying characters of a natural language in more than one font styles. For example, For Traditional Chinese, the multi-language system 30 only supports displaying Chinese characters in a font style “Ming Light” but not in other font styles like “Kai” or “Ming”. In English, the multi-language system 30 only supports displaying English characters in a font style “Times New Roman” but not in other font styles like “Arial” or “Verdana”. Therefore, a multi-language system 60 is provided according to the present invention to support displaying characters of a natural language in various font styles. The operations are described in the following.

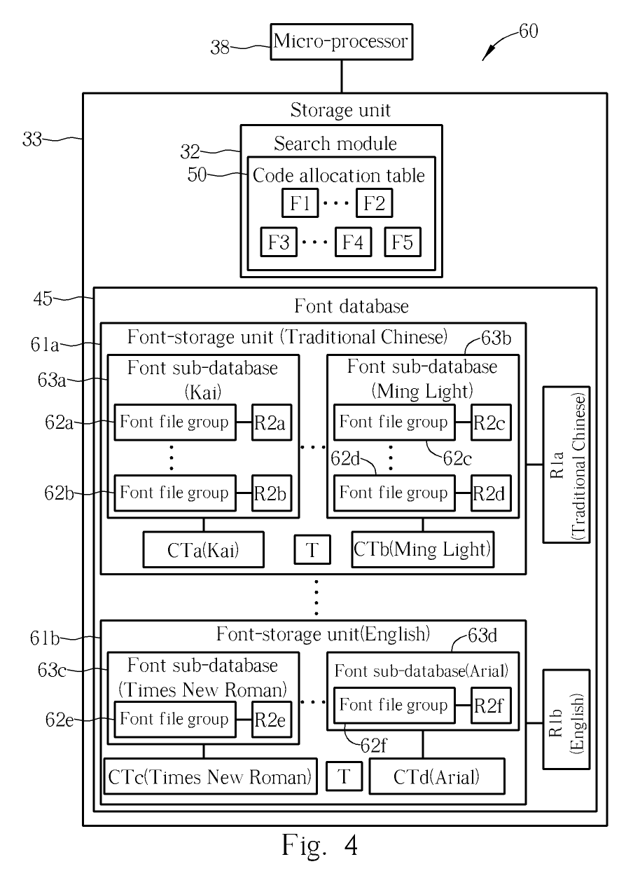

Please refer to FIG. 4. FIG. 4 is a functional block diagram of a multi-language system 60 according to the present invention. The multi-language system 60 supports displaying characters of a natural language in more than one font styles. A font file corresponds to a character code U and a font style code CT, and a character code U corresponds to at least one font file. Please note that components in the multi-language system 60 in FIG. 4 and components in the multi-language system 30 in FIG. 2 having the same names have the same functions. Therefore, redundant description of the functions of the above-mentioned components is omitted. The major difference between the multi-language system 60 and the multi-language system 30 is the font-storage units 61a and 61b. The font-storage unit 61a comprises a plurality of font sub-databases 63a and 63b. The font sub-database 63a storing font files of Traditional Chinese characters in a font style “Kai” corresponds to a font style code CTa, and the font sub-database 63b storing font files of Traditional Chinese characters in a font style “Ming Light” corresponds to a font style code CTb. The font sub-database 63a contains a plurality of character code sub-ranges R2a, R2b and corresponding font file groups 62a, 62b. The font sub-database 63b comprises a plurality of character code sub-ranges R2c, R2d and corresponding font file groups 62c, 62d. The font-storage unit 61b comprises a plurality of font sub-databases 63c and 63d. The font sub-database 63c storing font files of English characters in a font style “Times New Roman” corresponds to a font style code CTc, and the font sub-database 63d storing font files of English characters in a font style “Arial” corresponds to a font style code CTd. The font sub-database 63c contains a character code sub-range R2e and a corresponding font file group 62e. The font sub-database 63d contains a character code sub-range R2f and a corresponding font file group 62f. In the present embodiment, all font sub-databases in the same font-storage unit correspond to a natural language and are for storing font files in different font styles. Moreover, each font file group contains at least one font file corresponding to a specific font style of a natural language, and the font file is stored at a font file address CA.

Therefore in the present embodiment, the multi-language system 60 supports displaying characters of two natural languages: Traditional Chinese and English. In addition, the multi-language system 60 supports displaying Traditional Chinese characters in two font styles: “Ming Light” and “Kai”. When displaying English characters, the multi-language system 60 supports two font styles: “Times New Roman” and “Arial”.

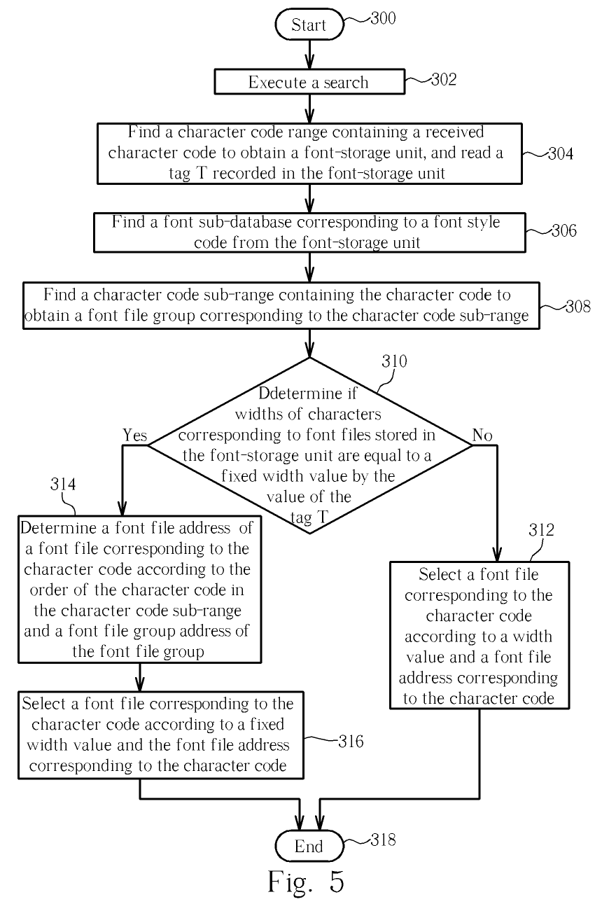

Please refer to FIG. 5. FIG. 5 is a flowchart describing the multi-language system 60 in FIG. 4 for selecting a font file corresponding to a character from a font database 45. The character corresponds to a character code U. The operations of selecting a font file corresponding to a character comprises following steps:

Step 300: Start.

Step 302: The micro-processor 38 executes the search module 32.

Step 304: The search module 32 finds a character code range containing the received character code U from the code allocation table 50 according to the character code U to obtain a font-storage unit corresponding to the character code range, and reads a tag T recorded in the font-storage unit.

Step 306: The search module 32 finds a font sub-database corresponding to a font style code selected by the user from the font-storage unit according to the character code U and the font style code.

Step 308: The search module 32 finds a character code sub-range containing the character code U from the font sub-database according to the character code U to obtain a font file group corresponding to the character code sub-range.

Step 310: The search module 32 determines if widths of the characters corresponding to the font files stored in the font-storage unit are equal to a fixed width value according to the value of the tag T recorded in the font-storage unit. If no (T=1), proceed to step 312; otherwise (T=0), proceed to step 314.

Step 312: The search module 32 selects a font file corresponding to the character code U according to a width value CV and a font file address SAC corresponding to the character code U of the character and then proceeds to step 318.

Step 314: The search module 32 determines a font file address SAC of a font file corresponding to the character code U according to the order OD of the character code U in the character code sub-range and a font file group address SAS of the font file group. The font file group address SAS is a font file address SAS of a first font file in the font file group.

Step 316: The search module 32 selects a font file corresponding to the character code U according to the fixed width value CW and the font file address SAC corresponding to the character code U.

Step 318: End.

The operations of step 300 to step 304 are similar to the operations of step 200 to step 204. Please refer to the description about step 200 to step 204 (of the multi-language system 30). In the present embodiment, a step 306 is a newly added step and is explained as follows. It is assumed that a user requires the multi-language system 60 to display a Traditional Chinese character [symbol] in a font style “Kai” by inputting a font style code CTa into the multi-language system 60. Hence, in step 306, the search module 32 finds a font sub-database 63a corresponding to the font style code CTa from the font-storage unit 51a corresponding to Traditional Chinese according to the character code U and the font style code CTa corresponding to the font style “Kai”. Afterwards, the search module 32 finds the character code sub-range R2a containing the character code U from the two character code sub-ranges R2a or R2b in the font sub-database 63a by using a binary search method. Each of the character code sub-ranges R2a and R2b contains a maximum value and a minimum value. That is, when the character code U is greater than the minimum value and less than the maximum value of the character code sub-range R2a, the character code U is in the character code sub-range R2a. Therefore, the search module 32 knows that the character code sub-range R2a corresponds to the font file group 52a. Hence, the search module 32 knows the font file group 62a corresponding to the character code sub-range R2a (step 308). The operations of the following step 310 to step 318 are the similar to the operations of step 208 to step 216 in FIG. 3. Therefore, redundant description about step 310 to step 318 is omitted.

In contrast to the related art, the present invention provides a multi-language system and a method for quickly selecting a font file corresponding to a character from a font database. The method comprises firstly finding a character code range containing a character code of the character from the code allocation table. That is, the character code is compared with a maximum value and a minimum value of each character code range. If the character code is greater than a minimum value and less than a maximum value of a specific character code range, the character code is in the character code range. Next, the multi-language system and the method according to the present invention select the font file corresponding to the character code. Consequently, the multi-language system and the method according to the present invention can efficiently save system resources applied in the embedded system. Moreover, no matter whether the font files of characters corresponding to the natural language are equal to a fixed width value or not, the multi-language system and the method can quickly select the font files.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for selecting a font file corresponding to a character from a font database, the character corresponding to a character code, the method applied in a multi-language system, the multi-language system comprising:
the font database comprising at least one character code range and at least one font-storage unit, wherein each of the font-storage units corresponds to at least one character code range, each of the font-storage units is utilized for storing at least one font file corresponding to a natural language, and each of the font files corresponds to a character code and is stored at a font file address in the font-storage unit; and
a code allocation table comprising at least one field, wherein each of the fields is utilized for recording a corresponding relationship between each of the character code ranges and the corresponding font-storage unit;
the method comprising:
(a) finding a character code range containing the character code from the code allocation table according to the character code to obtain a font-storage unit corresponding to the character code range;
(b) obtaining a font file address of the font file corresponding to the character code from the font-storage unit according to the character code; and
(c) selecting the font file corresponding to the character code from the font-storage unit according to the font file address.

2. The method of claim 1, wherein each of the font-storage units comprises at least one character code sub-range and at least one font file group; each of the font file groups comprises at least one font file stored at a font file address, each of the character code sub-ranges corresponds to a font file group; step (b) further comprises the following sub-steps:
(d) finding a character code sub-range containing the character code from the font-storage unit according to the character code; and
(e) obtaining the font file address of the font file corresponding to the character code according to the character code; and step (c) further comprises the following sub-steps:
(f) selecting the font file corresponding to the character code from a font file group corresponding to the character code sub-range stored in the font-storage unit according to the character code.

3. The method of claim 2, wherein in step (d), the character code sub-range containing the character code is found by utilizing a binary search method.

4. The method of claim 1, wherein the character code is a unicode, and the code allocation table is a unicode allocation table.

5. The method of claim 1, wherein the multi-language system is installed in a mobile unit.

6. The method of claim 5, wherein the mobile unit conforms to a GSM (global system for mobile communications) specification.

7. The method of claim 1, wherein each of the character code ranges contains a maximum value and a minimum value, and when the character code is greater than a minimum value and less than a maximum value of a specific character code range, the character code is in the specific character code range.

8. The method of claim 2, wherein each of the character code sub-ranges contains a maximum value and a minimum value, and when the character code is greater than a minimum value and less than a maximum value of a specific character code sub-range, the character code is in the specific character code sub-range.

9. The method of claim 1, wherein each of the font-storage units comprises at least one font sub-database, and the font sub-databases correspond to the same natural language for storing font files of different font styles.

10. The method of claim 9, wherein each of the characters corresponds to a font style code, and each of the font sub-databases corresponds to a font style code.

11. The method of claim 10, wherein each of the font sub-databases comprises at least one character code sub-range and at least one font file group; each of the font file groups comprises at least one font file stored at a font file address; each of the character code sub-ranges corresponds to a font file group; and step (b) further comprises the following steps:
(g) finding a font sub-database corresponding to the font style code;
(h) finding a character code sub-range containing the character code from the font sub-database according to the character code; and
(i) obtaining the font file address of the font file corresponding to the character code; and
the step of selecting a font file corresponding to the character code from the font sub-database according to the font file address, further comprises the following sub-step:
(j) selecting a font file corresponding to the character code from the font file group corresponding to the character code sub-range stored in the font sub-database according to character code.

12. The method of claim 1 1, wherein each of the character code sub-ranges contains a maximum value and a minimum value, and when the character code is greater than a minimum value and less than a maximum value of a specific character code sub-range, the character code is in the specific character code sub-range.

13. The method of claim 1, wherein when widths of font files of the characters corresponding to the natural language are equal to a fixed width value, in step (b) the font file address is determined by using the width of the font file and the order of the character code in the character code range.

14. The method of claim 13, wherein in step (c), the font file is selected by using the font file address and the fixed width value.

15. The method of claim 1, wherein when widths of font files of the characters corresponding to the natural language are not equal to a fixed width value; in step (c), the font file is selected by using the font file address and a width corresponding to the character.

16. A multi-language system for selecting a font file corresponding to a character from a font database, the character corresponding to a character code, and the multi-language system comprising:
the font database comprising at least one character code range and at least one font-storage unit, wherein each of the font-storage units corresponds to at least one character code range, each of the font-storage units is utilized for storing at least one font file corresponding to a natural language, and each of the font files corresponds to a character code and is stored at a font file address in the font-storage unit;
a code allocation table comprising at least one field, wherein each of the fields is utilized for recording a corresponding relationship between each of the character code ranges and the corresponding font-storage unit; and
a search module for finding a character code range containing the character code from the code allocation table according to the character code to obtain a font-storage unit corresponding to the character code range, for obtaining a font file address of a font file corresponding to the character code from the font-storage unit according to the character code; and for selecting the font file corresponding to the character code from the font-storage unit according to the font file address.

17. The multi-language system of claim 16, wherein each of the font-storage units comprises at least one character code sub-range and at least one font file group; each of the font file groups comprises at least one font file stored at a font file address, each of the character code sub-ranges corresponds to a font file group; and the search module finds a character code sub-range containing the character code from the font-storage unit according to the character code, obtains the font file address of the font file corresponding to the character code according to the character code, and selects the font file corresponding to the character code from a font file group corresponding to the character code sub-range stored in the font-storage unit according to the character code.

18. The multi-language system of claim 17, wherein the search module finds the character code sub-range containing the character code by utilizing a binary search method.

19. The multi-language system of claim 16, wherein the character code is a unicode, and the code allocation table is a unicode allocation table.

20. The multi-language system of claim 16 being installed in a mobile unit.

21. The multi-language system of claim 20, wherein the mobile unit conforms to a GSM (global system for mobile communications) specification.

22. The multi-language system of claim 16, wherein each of the character code ranges contains a maximum value and a minimum value, and when the character code is greater than a minimum value and less than a maximum value of a specific character code range, the character code is in the specific character code range.

23. The multi-language system of claim 17, wherein each of the character code sub-ranges contains a maximum value and a minimum value, and when the character code is greater than a minimum value and less than a maximum value of a specific character code sub-range, the character code is in the specific character code sub-range.

24. The multi-language system of claim 16, wherein each of the font-storage units comprises at least one font sub-database, and the font sub-databases correspond to the same natural language for storing font files of different font styles.

25. The multi-language system of claim 24, wherein each of the character corresponds to a font style code, and each of the font sub-databases corresponds to a font style code.

26. The multi-language system of claim 25, wherein each of the font sub-databases comprises at least one character code sub-range and at least one font file group; each of the font file groups comprises at least one font file stored at a font file address; each of the character code sub-ranges corresponds to a font file group; the search module finds a font sub-database corresponding to the font style code, finds a character code sub-range containing the character code from the font sub-database according to the character code, obtains the font file address of the font file corresponding to the character code, and selects a font file corresponding to the character code from the font file group corresponding to the character code sub-range stored in the font sub-database according to character code.

27. The multi-language system of claim 26, wherein each of the character code sub-ranges contains a maximum value and a minimum value, and when the character code is greater than a minimum value and less than a maximum value of a specific character code sub-range, the character code is in the specific character code sub-range.

28. The multi-language system of claim 16, wherein when widths of font files of the characters corresponding to the natural language are equal to a fixed width value, the search module determines the font file address by using the width of the font file and the order of the character code in the character code range.

29. The multi-language system of claim 28, wherein the search module selects the font file by using the font file address and the fixed width value.

30. The multi-language system of claim 16, wherein when widths of font files of the characters corresponding to the natural language are not equal to a fixed width value, the search module selects the font file by using the font file address and a width corresponding to the character.
